(19) United States
(12) Patent Application Publication
(10) Pub. No.: US 2026/0128870 A1
(43) Pub. Date: May 7, 2026

(54) SYSTEM FOR TRANSMITTING AN ENCRYPTED MESSAGE VIA QUANTUM CHANNEL AND RELATED METHOD

(71) Applicant: Massimo Bertaccini, Riolo Terme (IT)

(72) Inventor: Massimo Bertaccini, Riolo Terme (IT)

(21) Appl. No.: 18/953,914

(22) Filed: Nov. 20, 2024

(30) Foreign Application Priority Data
Nov. 29, 2023 (IT) 102023000025482

(51) Int. Cl. H04L 9/08; H04B 10/70

(52) U.S. Cl. CPC H04L 9/0852; H04B 10/70

(57) ABSTRACT

A system for transmitting an encrypted message via a quantum channel and a related method is described which uses a quantum key sharing algorithm designed to enable proper (secure and fast) communication between a transmitting station (not shown) and a receiving station (not shown).

### CROSS-REFERENCE TO RELATED APPLICATION

This application claims the benefit of and priority to Italian (IT) Patent Application No. 102023000025482 filed Nov. 29, 2023, the contents of which being incorporated by reference in their entirety herein.

### TECHNICAL FIELD

The present disclosure relates to a data encryption system and a method for communicating the same.

In particular, the present disclosure relates to a quantum cryptographic technique for data and a method for encrypting a message using an algorithm designed to be immune to dangerous channel attacks.

### BACKGROUND

Encryption plays a fundamental role in the communication of digital data to ensure an adequate level of communication security by meeting certain requirements, including the confidentiality and privacy of exchanged digital data.

These methods allow a transmitter and a receiver to mutually communicate confidential or secret data through a public and unsecured communication channel accessible to unauthorized users, such as the internet, a telephone network, or other similar channels.

The purpose of these methods is to transmit an unknown input, consisting of a plaintext message that remains concealed during communication, through an output suitable for transmission via a public channel.

Indeed, using these methods, the transmitter performs the encoding phase, in which it transforms a known input by encrypting it into the output using an encryption key.

Similarly, the receiver performs the decoding phase, decrypting the output to obtain the unknown input using a decryption key.

For this reason, when the encryption and decryption keys are identical, the encryption method is called symmetric.

Regarding symmetric encryption/decryption methods, while they are generally the fastest, they have limitations concerning the length of the message that can be encrypted/decrypted.

Indeed, two parties using a symmetric encryption method must exchange a key at least once through a private and/or secure communication channel and can then communicate confidentially via a public channel.

Asymmetric methods, on the other hand, allow for the encryption/decryption of messages of any length but require substantial processing time and computational resources.

One of the traditional encryption methods is the Rivest-Shamir-Adleman (RSA) method, as cited in prior documents: U.S. Pat. No. 5,146,500A, EP924895A2, and U.S. Pat. No. 6,081,597A.

Other encryption methods are based on chaos theory, utilizing nonlinear equations characterized in that there are no explicit formulas for calculating their solutions; numerical methods exist to compute the solutions of such equations in a finite number of steps.

Numerically, only approximate solutions can be obtained.

For example, a chaotic communication method is described in the article: Inoue E. Ushio T., Chaos communication using unknown input observer, Electronic and Communication in Japan, Part 3, 84, 12 (2001).

The above-mentioned known technique presents several significant drawbacks, including:
the outputs from the dynamic system are decimal numbers that are not necessarily finite,
it is not possible to correctly and completely process decimals with an infinite number of digits after the decimal point,
there is significant uncertainty in accurately reconstructing the plaintext message, as said approximation, such as truncation, introduces an error between the initially inserted input string and the reconstructed input string.

Therefore, if such a method were used for data encryption, discrepancies would arise between the transmitted unknown input and the reconstructed unknown input, resulting in incorrect communication.

This error becomes particularly significant when the unknown input has a reduced length.

Another disadvantage is that the presence of undefined decimals in the system's output necessitates an additional approximation phase to a finite decimal number.

The state of the art also includes the BB84 method and other similar quantum key exchange methods, as reported in prior documents: U.S. Pat. No. 7,536,012B1, WO2005060139A2, CN109617687B, US2019305942A1.

Such methods can cause several problems, such as inflexible conditions and solutions, inefficiency, and unreliability, as they only allow key exchange and not the transmission of encrypted messages, creating a particular need to address security-related problems, including:
following the transmission and exchange of the cryptographic key over the quantum channel, the message (plaintext) must be transmitted via the classical transmission channel,
it is not versatile, secure, and/or complete to implement because it requires multiple communication channels (quantum and classical), and the classical channel is not completely secure,
the identification of the sender is not possible because the classical channel will use a symmetric algorithm (AES, Vernam, etc.).

### BRIEF DESCRIPTION OF THE FIGURE

FIG. 1 is a schematic diagram for a quantum cryptographic technique for data and a method for encrypting a message using an algorithm designed to be immune to dangerous channel attacks according to various embodiments of the present disclosure.

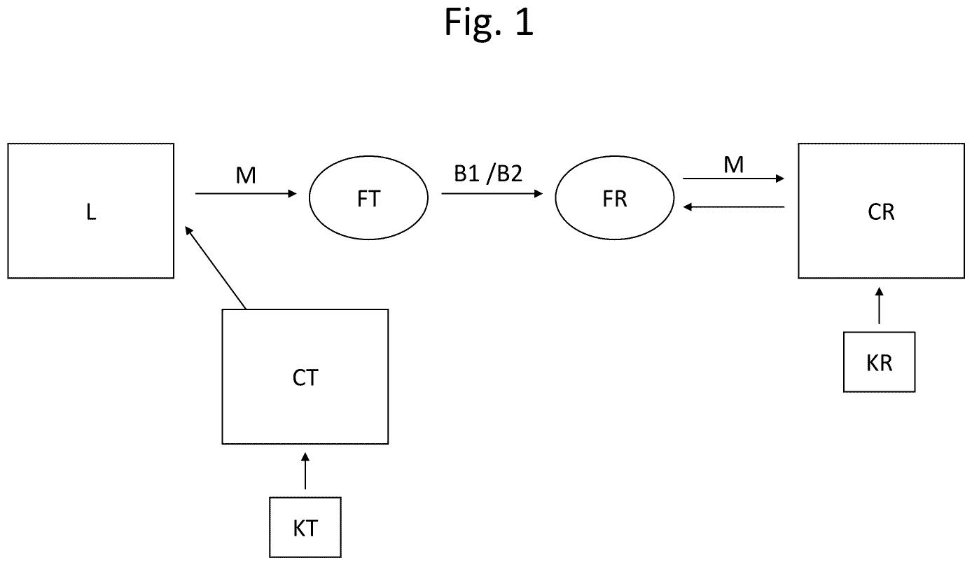

### DETAILED DESCRIPTION

A first objective of the present disclosure is to provide a system for transmitting an encrypted message and a related method that does not have the drawbacks of said classical methods/procedures and which is particularly simple and intuitive, accurately identifying the transmitting and receiving parties.

Another objective of the disclosure is to provide a system for transmitting an encrypted message with a simple/easy-to-implement structure, featuring low costs and reliable operation and usability, suitable for implementation over fiber optics and/or for space and/or satellite telecommunications.

These and other objectives are achieved in accordance with the present disclosure through the following features:
implementing direct message transmission in the quantum channel via a transmitting station,
performing authentication using a specific protocol, and
providing a message transmission speed that is at least equal to the speed of light.

In view of the related art described, a technical problem that the present disclosure aims to solve is the ability to use a quantum channel with photon exchange for said transmission and/or using entangled particles for the key.

A further aspect of the present disclosure is that its system for transmitting an encrypted message, as conceived compared to other similar and analogous products, provides a utility that no other device of its kind offers, as it employs a quantum channel (polarized light: photons) considered in no way “unbreakable”.

Therefore, the aim is to create a sort of space-time “tunnel” through which particles are instantaneously connected to each other, eliminating any latency issues.

In the related art, there is no system or method for the above-described activities/functions that is identical or similar to the one which is the subject of the present disclosure, based on the principles of quantum mechanics and designed to transfer and process information quickly and securely.

However, all the details of the disclosure may be replaced with other technically equivalent elements, and materials may differ depending on the requirements, without departing from the scope of protection of the disclosure.

Although the subject matter of the present disclosure has been described with particular reference to the appended FIGURE, the reference numbers used in the description and claims are for a better understanding of the disclosure and do not constitute any limitation of the scope of protection claimed.

The present disclosure is described with reference to one of its preferred embodiments, but it will be understood that other refinements/clarifications may be made with the evolution of technologies, variations, and modifications, without departing from the scope of protection of this inventive activity.

Therefore, those skilled in the art will understand that numerous modifications and variations are possible, which fall within the protection scope defined by the appended claims, especially in terms of reproduction scale, as the subjective/objective requirements will define the appropriate technical characteristics for such purpose, or depending on design variables, with the possibility of modifying certain processes and/or various elements.

Likewise, it is specified that further features and advantages of the disclosure will be more apparent in the light of the detailed description of a preferred, but not exclusive, embodiment of other forms, illustrated by way of a non-limiting example in the appended drawings, wherein the system for transmitting an encrypted message via a quantum channel, according to its embodiment of the present disclosure, consists of a quantum key that uses a sharing algorithm for said key via a quantum channel to allow for proper (secure and fast) communication between a transmitting station (not shown) and a receiving station (not shown), characterized in that it includes:
a transmitting quantum key KT (shared or entangled) of a certain number of transmitted bits (information/message M),
a transmitting computer CT designed to encode the message M (bit sequence) using said transmitting quantum key KT,
a photon laser L (one by one) governed by said transmitting computer CT using a counter (not shown),
a transmitting polarization filter FT (of the photons from the photon laser L) oriented and regulated by said transmitting computer CT, designed to uniquely polarize the photons of said photon laser L based on the choice of the transmitting quantum key KT (for a specific bit),
a receiving quantum key KR (shared or entangled) of a certain number of received bits (information/message M),
a receiving computer CR designed to decode said message M (bit sequence) based on said receiving quantum key KR (for a specific bit) and a receiving polarization filter FR (of the photons from the photon laser L received with an appropriate orientation);
wherein:
the polarization of the filter is determined by said polarization filter (FT or FR) connected to a photon detector (not shown), with a specific filter base (B1 or B2) having different orientations, such as vertical and/or horizontal: B1={I↑>, I→>}, or diagonal (West/East): B2={I [symbol] , I [symbol] },
and wherein:
each of said filter bases (B1 or B2) can be associated (in an analogous and reversible/interchangeable manner) with a specific bit of said shared quantum key (KT or KR) corresponding to a polarized bit of said message M (0 or 1), determining its orientation.

By way of example, let us assume that:
the transmitting station uses base B1={I↑>, I→>} when the transmitting quantum key KT corresponds to bit 1, and that:
the transmitting station uses base B2={I [symbol] , I/ [symbol] } when the transmitting quantum key KT corresponds to bit 0,
then the following occurs:
for each bit of the transmitting quantum key KT corresponding to bit 1, the transmitting station will use a transmitting polarization filter FT with base B1, i.e., in a vertical I↑> and horizontal I→> orientation, chosen uniquely based on the corresponding bit of the message M (0 or 1),
for each bit of the transmitting quantum key KT corresponding to bit 0, the transmitting station will use a transmitting polarization filter FT with base B2, i.e., in a diagonal (West/East) I [symbol] , I [symbol] orientation, chosen uniquely based on the corresponding bit of the message M (0 or 1).

Let us now analyze how the encoding of a message M=[M1=0, M2=1, M3=0, M4=1, M5=1] encoded with the key KT=[KT1=1, KT2=1, KT3=0, KT4=1, KT5=0] is performed:
for KT1=1, the base to be used will be B1, the first bit of the message is M1=0, so the first photon will be transmitted with polarization I↑>;
for KT2=1, the base to be used will be B1, the second bit of the message is M2=1, so the second photon will be transmitted with polarization I→>;
for KT3=0, the base to be used will be B2, the third bit of the message is M3=0, so the third photon will be transmitted with polarization I [symbol] ;
for KT4=1, the base to be used will be B1, the fourth bit of the message is M4=1, so the fourth photon will be transmitted with polarization I→>;
for KT5=0, the base to be used will be B2, the fifth bit of the message is M5=1, so the fifth photon will be transmitted with polarization I [symbol] .

To summarize with an encoding table:

KT1 = 1 → (B1) → M1 = 0 → I↑>
KT2 = 1 → (B1) → M2 = 1 → I→>
KT3 = 0 → (B2) → M3 = 0 → I [symbol]
KT4 = 1 → (B1) → M4 = 1 → I→>
KT5 = 0 → (B2) → M5 = 1 → I

[symbol]

Thus, the encoding outcome is: I↑>, I→>, I [symbol] , I→>, I [symbol] .

Now, let us analyze how the decoding of said encrypted message: I↑>, I→>, I [symbol] , I→>, I [symbol] is performed.

A receiving computer CR is designed to orient the polarization filter according to said quantum key KR to decode the message M (bit sequence), based on the encoding scheme outlined in the encoding example.

To summarize with a decoding table:

KR1 = 1 → (B1) → I↑> → M1 = 0
KR2 = 1 → (B1) → I→> → M2 = 1
KR3 = 0 → (B2) → I [symbol] → M3 = 0
KR4 = 1 → (B1) → I→> → M4 = 1
KR5 = 0 → (B2) → I [symbol] → M5 = 1

Thus, the decoded message is M=[M1=0, M2=1, M3=0, M4=1, M5=1] decoded with the key KR=[KR1=1, KR2=1, KR3=0, KR4=1, KR5=0].

In detail, the method for transmitting an encrypted message via quantum channel of the present disclosure includes the following:
encoding a message M using a transmitting quantum key KT,
polarizing the photons of the photon laser L using a transmitting polarization filter FT corresponding to a specific filter base (B1 or B2) with one or more orientations (reversible/interchangeable), preferably two.
polarizing the photons of the photon laser L using a receiving polarization filter FR corresponding to one of said orientations,
decoding the message M using a receiving quantum key KR.

1. A system for transmitting an encrypted message via a quantum channel allowing communication between a transmitting station and a receiving station, comprising:
a transmitting quantum key KT of a certain number of transmitted bits (information/message M),
a transmitting computer CT designed to encode the message M (bit sequence) using said transmitting quantum key KT,
a photon laser L governed by said transmitting computer CT using a counter (not shown),
a transmitting polarization filter FT (of the photons from the photon laser L) oriented and regulated by said transmitting computer CT, designed to uniquely polarize the photons from said photon laser L based on the choice of said transmitting quantum key KT (for a specific bit),
a receiving quantum key KR of a certain number of received bits (information/message M),
a receiving computer CR designed to decode said message M (bit sequence) using said receiving quantum key KR (for a specific bit) and a receiving polarization filter FR (of the photons from the photon laser L received with an appropriate orientation);
wherein:
the polarization of the filter is assigned by said polarization filter (FT or FR) connected to a photon detector (not shown), with a specific filter base (B1 or B2) having different orientations, and wherein:
each of said filter bases (B1 or B2) can be associated (in an analogous and reversible/interchangeable manner) with a specific bit of said shared quantum key (KT or KR) corresponding to a bit of said message M polarized (0 or 1), determining its orientation.

2. The system for transmitting an encrypted message via a quantum channel according to claim 1, wherein said filter base B1 has a vertical and/or horizontal type orientation.

3. The system for transmitting an encrypted message via a quantum channel according to claim 2, wherein said filter base B1 has an orientation type: B1={I↑>, I→>}.

4. The system for transmitting an encrypted message via a quantum channel according to claim 1, wherein said filter base B2 has a vertical and/or horizontal type orientation.

5. The system for transmitting an encrypted message via a quantum channel according to claim 4, wherein said filter base B2 has an orientation type: B2={I↑>, I→>}.

6. The system for transmitting an encrypted message via a quantum channel according to claim 1, wherein said filter base B1 has a diagonal (West/East) orientation.

7. The system for transmitting an encrypted message via a quantum channel according to claim 6, wherein said filter base B1 has an orientation type: B1={I [symbol] , I [symbol] }.

8. The system for transmitting an encrypted message via a quantum channel according to claim 1, wherein said filter base B2 has a diagonal (West/East) orientation.

9. The system for transmitting an encrypted message via a quantum channel according to claim 8, wherein said filter base B2 has an orientation type: B2={I [symbol] , I [symbol] }.

10. A method for transmitting an encrypted message via a quantum channel, comprising the following steps:
providing the system for transmitting an encrypted message via a quantum channel according to claim 1,
encoding said message M using said transmitting quantum key KT,
polarizing said photons from said photon laser L using said transmitting polarization filter FT corresponding to a specific filter base (B1 or B2) with one or more orientations (reversible/interchangeable),
polarizing said photons from said photon laser L using said receiving polarization filter FR corresponding to one of said orientations,
decoding said message M using said receiving quantum key KR.
